(19) United States
(12) Patent Application Publication
(10) Pub. No.: US 2025/0065702 A1
(43) Pub. Date: Feb. 27, 2025

(54) FRAMELESS VEHICLE DOOR ASSEMBLY

(71) Applicant: Geiser, Inc., Phoenix, AZ (US)

(72) Inventor: Sean Geiser, Phoenix, AZ (US)

(21) Appl. No.: 18/452,744

(22) Filed: Aug. 21, 2023

(51) Int. Cl. B60J 5/04

(52) U.S. Cl. CPC B60J 5/048; B60J 5/0469

(57) ABSTRACT

The disclosed frameless vehicle door assembly according to various aspects of the subject technology may be attachable to a vehicle body of a UTV or other 4×4 vehicle. The frameless vehicle door assembly may include an interior cover formed in a manner to enclose the internals of the vehicle body and provide structural rigidity to the door assembly. The frameless vehicle door assembly may also include a joint enabling the interior cover to pivot with respect to the vehicle body and an outer cover securely mounted to the interior cover using fasteners, wherein the outer cover completes the door assembly.

### BACKGROUND OF THE INVENTION

### Technical Field

This invention relates generally to a vehicle door and more particularly to a frameless vehicle door assembly.

### State of the Art

Doors play a vital role in the functionality and safety of utility task vehicles (UTVs) and other 4×4 vehicles. These doors are essential components that cover the door openings on the vehicles, providing protection and security for occupants during off-road excursions. The primary purpose of UTV doors is to shield passengers and drivers from external elements such as dirt, rocks, and potential hazards while ensuring a comfortable and secure ride. Traditional door designs in the industry typically employ a tubular frame structure with a sheet metal “skin” mounted to the frame to enclose the door openings.

While conventional tubular frame design with a sheet metal skin has served its purpose, it presents certain limitations that necessitate an innovative solution. One issue with conventional door assemblies is the weight and complexity associated with the tubular frame structure. The additional weight can impact the vehicle's overall performance, handling, and fuel efficiency, particularly during challenging off-road terrains. Moreover, the traditional door assembly structure may restrict easy accessibility to the vehicle's interior and obstruct the driver's field of vision. These drawbacks call for a new approach to UTV door design that reduces weight, enhances accessibility, and maintains structural integrity.

Accordingly, there is a need for a novel “frameless” door assembly designed for UTVs and 4×4 vehicles that effectively closes off the internals of the door while providing the necessary rigidity to support the door's structure, that retains the functionality of a framed door while offering enhanced flexibility, and that also improves UTV door performance, accessibility, and overall functionality.

### SUMMARY OF THE TECHNOLOGY

The disclosed frameless vehicle door assembly according to various aspects of the subject technology may be attachable to a vehicle body of a UTV or other 4×4 vehicle. The frameless vehicle door assembly may comprise an interior cover formed in a manner to enclose the internals of the vehicle body and provide structural rigidity to the door assembly. The frameless vehicle door assembly may also comprise a joint enabling the interior cover to pivot with respect to the vehicle body and an outer cover securely mounted to the interior cover using fasteners, wherein the outer cover completes the door assembly.

### BRIEF DESCRIPTION OF THE DRAWINGS

A more complete understanding of the subject technology may be derived by referring to the detailed description when considered in connection with the following illustrative figures. In the following figures, like reference numbers refer to similar elements and steps throughout the figures.

FIG. 1 representatively illustrates a perspective outside view of a frameless vehicle door assembly installed on a vehicle body in accordance with an embodiment of the subject technology;

FIG. 2 representatively illustrates a perspective inside view of a frameless vehicle door assembly installed on a vehicle body in accordance with an embodiment of the subject technology;

FIG. 3 representatively illustrates a front view of an interior cover of a frameless vehicle door assembly in accordance with an embodiment of the subject technology;

FIG. 4 representatively illustrates a front view of an outer cover of a frameless vehicle door assembly in accordance with an embodiment of the subject technology;

FIG. 5 representatively illustrates a perspective view of an outer cover and an interior cover of a frameless vehicle door assembly in accordance with an embodiment of the subject technology;

FIG. 6 representatively illustrates a rear view of an interior cover of a frameless vehicle door assembly in accordance with an embodiment of the subject technology;

FIG. 7 representatively illustrates a perspective view of an upper bracket of a frameless vehicle door assembly in accordance with an embodiment of the subject technology;

FIG. 8 representatively illustrates a perspective view of a lower bracket of a frameless vehicle door assembly in accordance with an embodiment of the subject technology;

FIG. 9 representatively illustrates a front view of a latch plate of a frameless vehicle door assembly in accordance with an embodiment of the subject technology;

FIG. 10 representatively illustrates a perspective view of a frameless vehicle door assembly in accordance with an embodiment of the subject technology; and

FIG. 11 representatively illustrates another perspective view of a frameless vehicle door assembly in accordance with an embodiment of the subject technology.

### DETAILED DESCRIPTION OF EMBODIMENTS

The subject technology may be described in terms of functional components. Such functional components may be realized by any number of components configured to perform the specified functions and achieve the various results. For example, the subject technology may employ various brackets, coupling components, covers, fasteners, joints, latch plates, and the like, which may carry out a variety of functions. In addition, the subject technology may be practiced in conjunction with any one of various vehicles, and the frameless vehicle door assembly described herein is merely one exemplary application for the technology. For the purposes of this application, the term “vehicle” means any suitable 4×4 vehicle, such as a utility task vehicle (UTV) and the like.

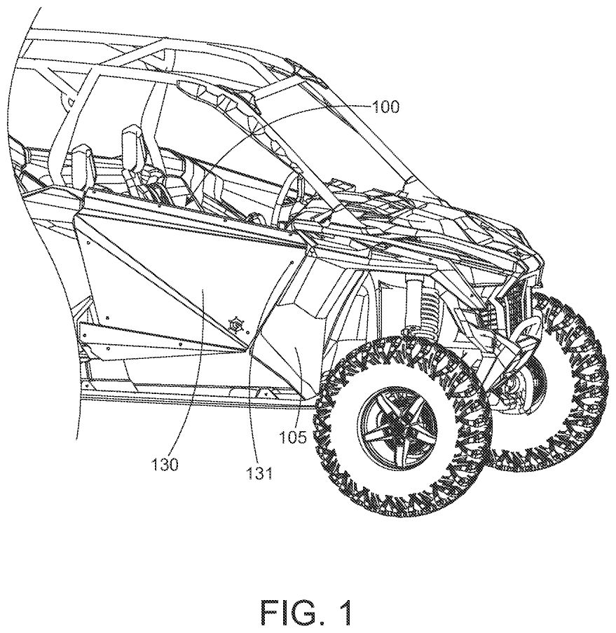

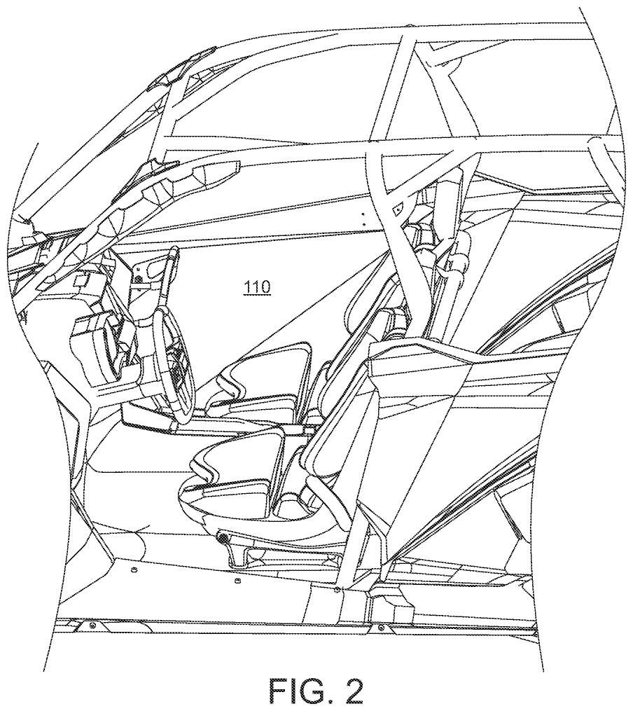

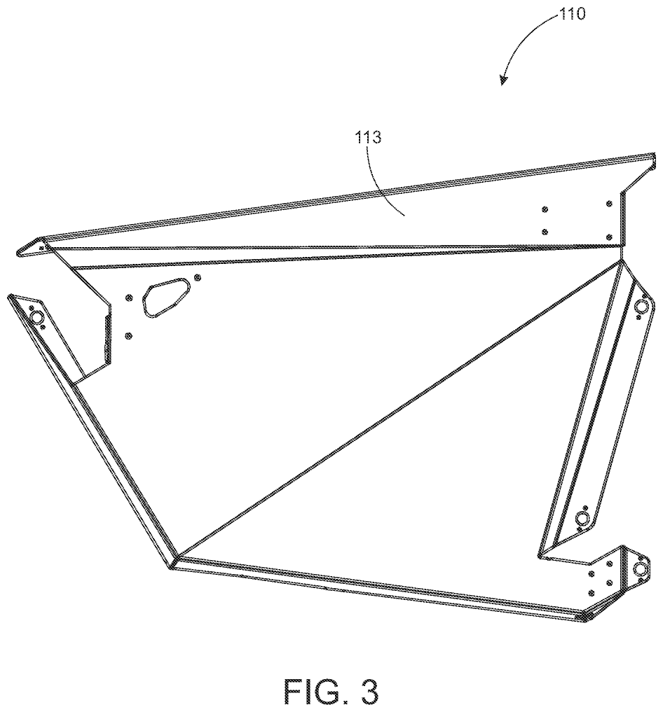

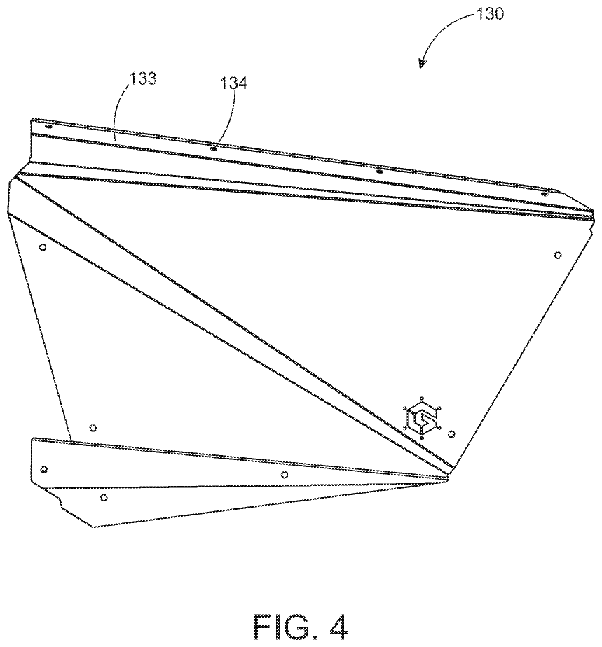

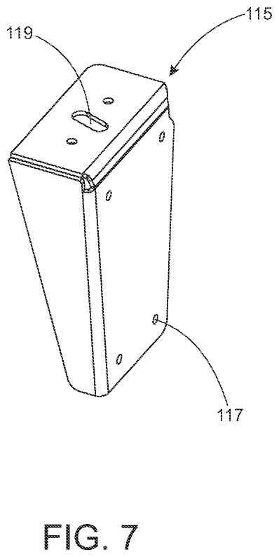

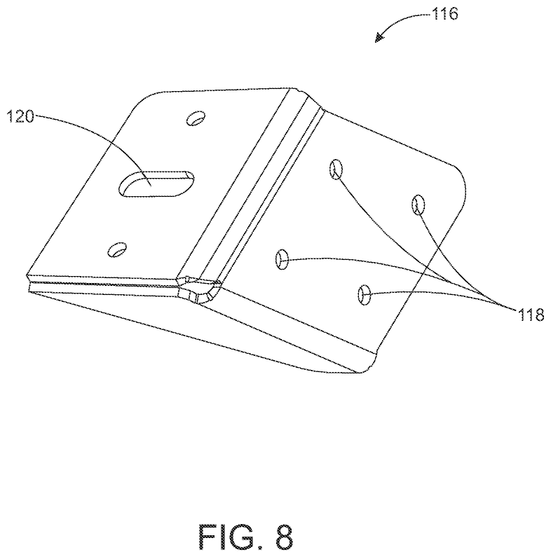

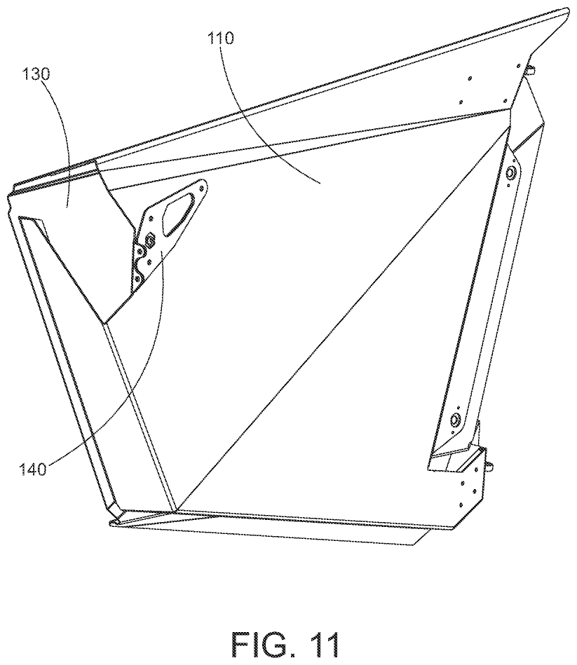

Referring to FIGS. 1-11, a frameless vehicle door assembly 100 may comprise an interior cover 110 that encloses internals of a vehicle body 105 while providing structural rigidity, a joint 120 that connects the interior cover 110 to the vehicle body 105 of the UTV or 4×4 vehicle, enabling the interior cover 110 to pivot or open and close with respect to the vehicle body 105, and an outer cover 130, securely mounted to the interior cover 110 using fasteners 131, completing the door assembly's exterior appearance.

The interior cover 110 may confer structural integrity and house the internal components of the UTV or 4×4 vehicle. The interior cover 110 may be shaped and contoured, tailored to the vehicle's specific door opening, resulting in a flush and seamless fit, enhancing the overall appearance of the door assembly 100. In some embodiments, the interior cover 110 may comprise one or more interior panels and trim elements to enhance the aesthetic appearance of the vehicle interior. The interior cover 110 may be constructed from lightweight materials such as aluminum, carbon fiber, fiberglass, or composites.

The interior cover 110 may comprise a plurality of protruding surfaces 113 that are integrally formed as part of its shape and structure. The protruding surfaces 113 may be used to securely attach the interior cover 110 to the outer cover 130. The protruding surfaces 113 may be integrated on the interior cover 110 to provide optimal support and stability. As part of the manufacturing process of the interior cover 110, the protruding surfaces 113 may be precisely shaped and formed, ensuring seamless integration with the overall structure of the interior cover 110, thereby eliminating the need for separate components, reducing assembly complexity and material usage. Additionally, by being an integral part of the interior cover's shape and structure, the integrally formed protruding surfaces 113 may effectively distribute any external forces or impacts, optimizing the door assembly's overall strength and durability. Each protruding surface 113 may contain apertures 114 therein for receiving fasteners therethrough and which serve as anchor points for attaching the outer cover 130 to the interior cover 110. The apertures 114 may be placed to align with corresponding apertures on the outer cover 130, facilitating a secure and precise connection between the interior cover 110 and the outer cover 130. The alignment of the protruding surface apertures 114 with the apertures of the outer cover 130 may ensure a flush and uniform assembly, enhancing the door assembly's visual appeal and aerodynamic performance.

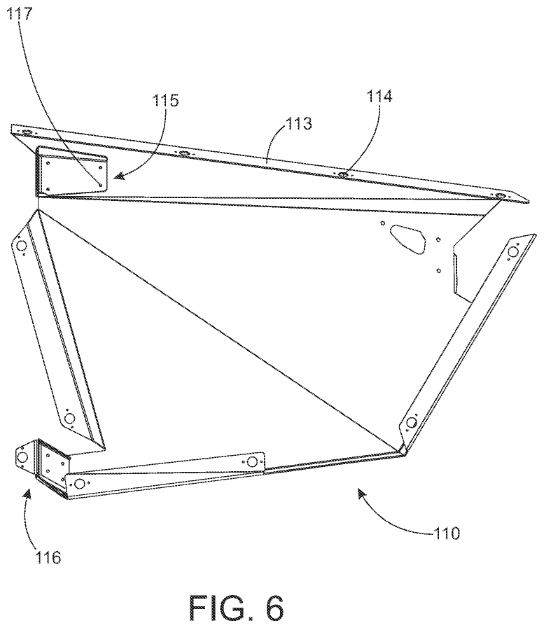

The interior cover 110 may also comprise an upper bracket 115 and a lower bracket 116, which may be securely mounted thereto and may provide additional support and attachment points for the interior cover 110 to the body of the UTV or 4×4 vehicle. As shown in FIGS. 6-8, the upper bracket 115 may be positioned at the top section of the interior cover 110, while the lower bracket 116 may be positioned at the bottom section. The upper bracket 115 and lower bracket 116 may comprise apertures 117 and 118, respectively, which serve as mounting points for securing the upper bracket 115 and lower bracket 116 to the interior cover 110 itself. The upper bracket 115 and lower bracket 116 contain additional apertures 119 and 120, respectively, that facilitate mounting the interior cover 110 to the body of the UTV or 4×4 vehicle. The apertures 119, 120 may align with corresponding attachment points on the vehicle body 105, allowing for a seamless and robust attachment of the interior cover 110 to the vehicle body 105.

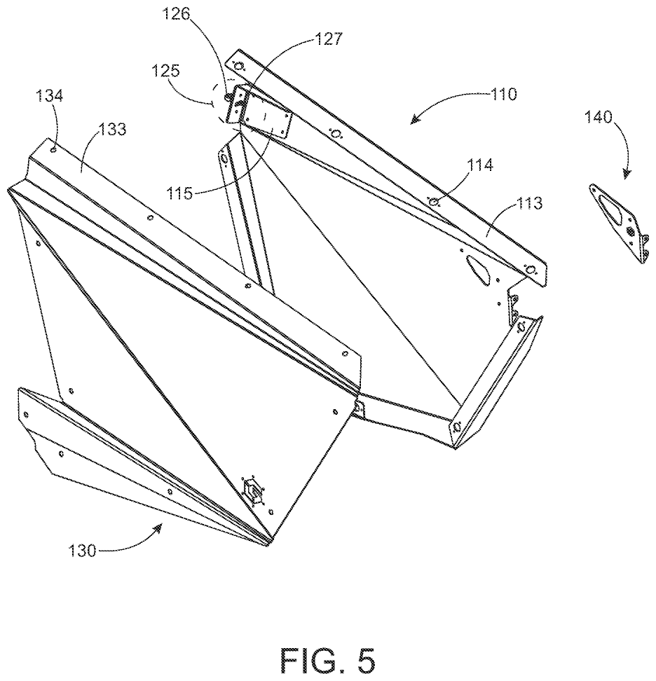

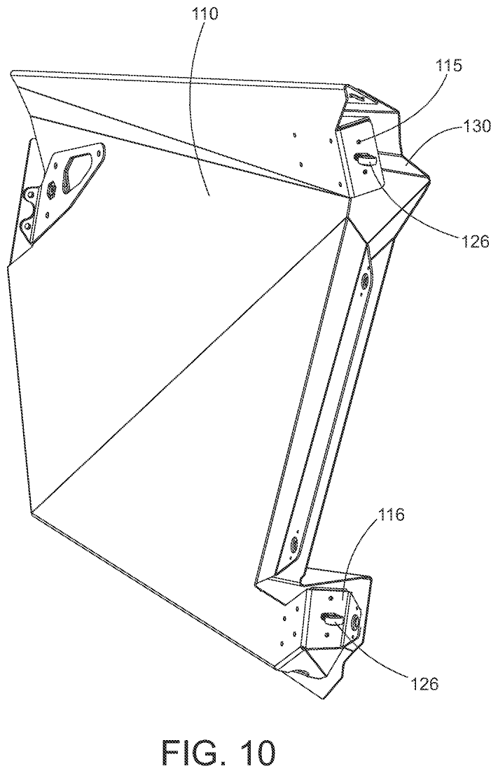

Referring to FIGS. 5 and 10, the joint 125 may connect the interior cover 110 to the vehicle body 105, enabling the interior cover 110 to pivot or open and close with respect to the vehicle body 105. The joint 125 may comprise a pivotal mechanical component for enabling smooth and multi-directional door movement. For example, in one embodiment, the joint 125 may comprise a heim joint that comprises a ball and socket assembly 126 coupled to an end of a rod 127 that facilitates frictionless rotation, reducing wear and tear during operation.

In one embodiment, the rod 127 may be inserted through the aperture 118 of the upper bracket 115 and secured thereto and the socket assembly 126 may be secured to the vehicle body 105, thereby forming a secure connection between the interior cover 110 and the vehicle body 105. This configuration allows for smooth and precise movement of the interior cover 110 with respect to the vehicle body 105, providing easy access to the vehicle's interior when the door is open and ensuring a snug and accurate fit when the door is closed. Similarly, in another embodiment, the joint 125 may be inserted through the aperture 120 of the lower bracket 116, connecting the interior cover 110 to the vehicle body 105. Moreover, in yet another embodiment, two joints 125 may be utilized, with each joint 125 connecting the interior cover 110 to the vehicle body 105 through apertures 118 and 119 of the upper bracket 115 and lower bracket 116, respectively. This dual joint configuration may further enhance the stability of the frameless vehicle door assembly 100. The joint 125 may comprise any suitable joint, such as a rod end bearing, clevis joint, ball joint, spherical bearing, and universal joint.

The outer cover 130 may serve as the door assembly's external surface. The outer cover 130 not only enhances the door's aesthetics but also provides additional structural support to the assembly 10 and protection against external elements and potential impacts. The outer cover 130 may be designed to complement the vehicle's overall design and allows for customization with various styles, colors, and textures to suit the preferences of vehicle owners. The outer cover 130 may be constructed from durable materials such as sheet metal, plastic, or advanced composite materials.

Similar to the interior cover 110, the outer cover 130 may comprise a plurality of protruding surfaces 133 that are integrally formed as part of its shape and structure. The protruding surfaces 133 may be used to securely attach the outer cover 130 to the interior cover 110. The protruding surfaces 133 may be integrated on the outer cover 130 to provide optimal support and stability. As part of the manufacturing process of the outer cover 130, the protruding surfaces 133 may be precisely shaped and formed, ensuring seamless integration with the overall structure of the outer cover 130.

Each protruding surface 133 may contain apertures 134 therein, which serve as anchor points for attaching the outer cover 130 to the interior cover 110. The apertures 134 may be placed to align with the corresponding apertures 114 on the interior cover 110, facilitating a secure and precise connection between the outer cover 130 and the interior cover 110. The alignment of the apertures 134 of the outer cover 130 with the apertures 114 of the interior cover 110 may ensure a flush and uniform assembly, enhancing the door's visual appeal and aerodynamic performance. By being an integral part of the shape and structure of the outer cover 130, the integrally formed protruding surfaces 133 may effectively distribute any external forces or impacts, optimizing the door assembly's overall strength and durability. Furthermore, the incorporation of the protruding surfaces 133 directly into the outer cover 130 eliminates the need for additional hardware or fasteners, contributing to the door assembly's sleek and minimalist appearance.

The outer cover 130 may be coupled to the interior cover 110 using fasteners 131. The fasteners 131 may be inserted through apertures 134 of the protruding surfaces 133, which are a part of the outer cover 130, and through corresponding apertures 114 of the mounting protruding surfaces 113, which are part of the interior cover 110. This innovative design allows for precise alignment and attachment of the two covers, resulting in a flush and cohesive door structure. The secure coupling provided by the fasteners 131 ensures that the outer cover 130 remains firmly mounted to the interior cover 110, allowing for smooth door operation and enhanced durability of the frameless vehicle door assembly 100. In one embodiment, the fasteners 131 may comprise Dzus Pins, which allow for quick release mounting and easy removal and replacement, streamlining maintenance, repairs, or customization without the need for extensive disassembly and without compromising the structural integrity of the frameless door assembly 100. In other embodiments, the fasteners 131 may comprise quarter-turn fasteners, cam-lock fasteners, snap fasteners, quick-release latches, toggle latches, hook-and-eye fasteners, and the like.

The frameless vehicle door assembly 100 may further comprise a weather sealing component (not shown). The weather sealing component may be integrated within the edges of the interior cover 110 and may form a tight and reliable seal between the interior cover 110 and the vehicle body 105 when the interior cover 110 is mounted to the vehicle body 105, safeguarding the vehicle's interior from external elements. In this regard, the weather sealing component may ensure that the frameless door assembly 100 remains impervious to water, dust, and debris, enhancing passenger comfort and preserving the internal mechanisms and electronics housed within the vehicle. The weather sealing component may comprise rubber gaskets, weather stripping, or similar materials.

As shown in FIGS. 5 and 9-11, the frameless door assembly 100 may further comprise an integrated locking component, such as a door latch plate 140 for securely holding the frameless vehicle door assembly 100 in a closed position. The door latch plate 140 may be located on the interior cover 110 of the door assembly 100, near its edges. The door latch plate 140 may comprise attachment points or apertures 142 for securing the latch plate 140 to the interior cover 110. The latch plate 140 may be fastened to the interior cover 110 using screws or bolts (not shown) that are inserted through the apertures 142, ensuring a secure and reliable connection.

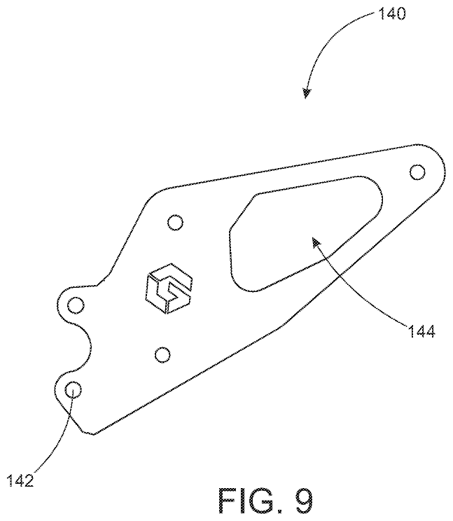

Additionally, as shown in FIG. 9, the latch plate 140 may comprise an opening 144 that is configured to engage with a corresponding latch or striker plate on the vehicle's body when the door is closed. When the frameless vehicle door is shut, the door latch plate 140 may extend from the interior cover 110 and engage with the vehicle's door frame or body-mounted latch (not shown), creating a secure and locked position and effectively holding the door in place and preventing it from opening unintentionally during vehicle operation.

The particular implementations shown and described are illustrative of the technology and its best mode and are not intended to otherwise limit the scope of the subject technology in any way. Indeed, for the sake of brevity, conventional manufacturing, connection, preparation, and other functional aspects of the apparatus may not be described in detail. Furthermore, the connections and points of contact shown in the various figures are intended to represent exemplary physical relationships between the various elements. Many alternative or additional functional relationships or physical connections may be present in a practical system.

In the foregoing description, the technology has been described with reference to specific exemplary embodiments. Various modifications and changes may be made, however, without departing from the scope of the subject technology as set forth. The description and figures are to be regarded in an illustrative manner, rather than a restrictive one and all such modifications are intended to be included within the scope of the subject technology. Accordingly, the scope of the technology should be determined by the generic embodiments described and their legal equivalents rather than by merely the specific examples described above. For example, the components and/or elements recited in any apparatus embodiment may be combined in a variety of permutations to produce substantially the same result as the subject technology and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

The terms “comprises,” “comprising,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the subject technology, in addition to those not specifically recited, may be varied, or otherwise particularly adapted to specific environments, manufacturing specifications, design parameters or other operating requirements without departing from the general principles of the same.

The subject technology has been described above with reference to an exemplary embodiment. However, changes and modifications may be made to the exemplary embodiment without departing from the scope of the subject technology. These and other changes or modifications are intended to be included within the scope of the subject technology.

1. A frameless vehicle door assembly attachable to a vehicle body, comprising:
an interior cover formed in a manner to enclose the internals of the vehicle body and provide structural rigidity to the door assembly;
a joint coupled to the interior cover and vehicle body, enabling the interior cover to pivot with respect to the vehicle body; and
an outer cover securely mounted to the interior cover using fasteners, wherein the outer cover completes the door assembly.

2. The frameless vehicle door assembly of claim 1, wherein the interior cover comprises:
a main component forming the central structure of the interior cover;
an upper bracket coupled to the main component; and
a lower bracket coupled to the main component.

3. The frameless vehicle door assembly of claim 2, wherein the upper bracket and the lower bracket comprise multiple attachment points for securing the interior cover to the vehicle body.

4. The frameless vehicle door assembly of claim 2, wherein the main component comprises predefined mounting points for fastening the joint to facilitate the pivoting of the interior cover and outer cover.

5. The frameless vehicle door assembly of claim 1, wherein the interior cover is constructed from a lightweight material selected from the group consisting of aluminum, carbon fiber, fiberglass, and composites.

6. The frameless vehicle door assembly of claim 1, wherein the interior cover is shaped to conform to the contours of a door opening of the vehicle body.

7. The frameless vehicle door assembly of claim 1, wherein the joint comprises a heim joint allowing smooth and multi-directional pivoting of the interior cover with respect to the vehicle body.

8. The frameless vehicle door assembly of claim 1, wherein the fasteners comprise Dzus Pins.

9. The frameless vehicle door assembly of claim 1, wherein the outer cover is constructed from a durable material selected from the group consisting of sheet metal, plastic, and composite materials.

10. The frameless vehicle door assembly of claim 1, wherein the interior cover comprises structural members to enhance the overall strength and stiffness of the door assembly.

11. The frameless vehicle door assembly of claim 1, further comprising an integrated locking component to secure the door in a closed position.

12. The frameless vehicle door assembly of claim 1, wherein the interior cover comprises one or more interior panels and trim elements to enhance the aesthetic appearance of the vehicle interior.

13. A method for manufacturing a frameless vehicle door assembly attachable to a vehicle body, comprising:
forming an interior cover to enclose the internals of the vehicle body and provide structural rigidity to the door assembly;
integrating a joint into the interior cover to enable smooth pivoting of the interior cover with respect to the vehicle body; and
attaching an outer cover to the interior cover using fasteners to complete the door assembly.

14. The method of claim 13, wherein forming the interior cover comprises molding or shaping a lightweight material selected from the group consisting of aluminum, carbon fiber, fiberglass, and composites.

15. The method of claim 13, further comprising shaping the interior cover to conform to the contours of a door opening of the vehicle body.

16. The method of claim 13, wherein integrating the joint comprises connecting a ball and socket to facilitate multi-directional pivoting of the interior cover and outer cover with respect to the vehicle body.

17. The method of claim 13, further comprising fabricating the outer cover from a durable material selected from the group consisting of sheet metal, plastic, and composite materials.

18. The method of claim 13, further comprising integrating a locking component into the interior cover to secure the door in a closed position.

19. The method of claim 13, wherein attaching the outer cover to the interior cover using fasteners comprises aligning the outer cover with the interior cover and securing the fasteners to create a detachable connection.

20. The method of claim 19, wherein the fasteners comprise Dzus Pins.
